(19) United States
(12) Patent Application Publication
(10) Pub. No.: US 2007/0164194 A1
(43) Pub. Date: Jul. 19, 2007

(54) Observation apparatus with focal position control mechanism

(75) Inventors: Shunsuke Kurata, Kamiina-gun (JP); Haruyuki Tsuji, Ina-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/724,416

(22) Filed: Mar. 15, 2007

(30) Foreign Application Priority Data
Sep. 16, 2004 (JP) P2004-269669
Sep. 13, 2005 (JP) PCT/JP05/16843

(51) Int. Cl. G02B 27/40

(52) U.S. Cl. 250/201.4

(57) ABSTRACT

An AF apparatus for a microscope (1) of the present invention includes: an observational optical system (6) which radiates light on an object under inspection (3) via one of multiple interchangeable objective lens (2) and which has a CCD (imaging device) (5) for observing reflected light from the object under inspection (3); a light flooding portion (7) which radiates a laser (non-visible light) on the object under inspection (3) via the objective lens (2) of the observational optical system (6); a focal point detection optical system (10) which has a photo-detector (photo-electric conversion portion) (8) that is arranged at an image surface of a light figure of the reflected laser from the object under inspection and that outputs signals corresponding to the position of the light figure inside the image surface, and which detects the relative distance between the objective lens (2) and the object under inspection (3); an object position adjusting unit (11) which adjusts the focal position of the object under inspection (3) based on the output signals from the focal point detection optical system (10); and a diaphragm unit (12) which adjust the area on which the laser is radiated so as to be inside the imaging area of the CCD (5).

### BACKGROUND OF THE INVENTION

1. Field of the Invention

The present invention relates to an observation apparatus with a focal position control mechanism.

Priority is claimed on Japanese Patent Application No. 2004-269669, filed Sep. 16, 2004, the content of which is incorporated herein by reference.

2. Description of Related Art

These days, an observation apparatus such as a microscope which can be used to observe a minute sample under inspection or which can record the observed image onto a video is widely used in fields ranging from biological research to the inspection steps of industrial manufacture. In general, in the case in which such a microscope is used, a focusing operation is conducted in order to adjust the focus on the observed sample by operating a focusing handle. However, especially in a case of a shallow focal depth and a narrow focal range, such as a high-power objective lens, experience and skill is required for conducting quick focusing.

If operability is not effective or preferable, there is a bad influence such as fatigue on the operator, lower productive or operational efficiency, and the like. Especially in inspection steps of a routine operation or the like, it is significantly important to quickly conduct this operation in order to make the inspection time shorter.

In view of such conditions, there are various proposals for apparatuses with a focal position control mechanism (auto-focus: AF) for a microscope that can automatically conduct such a focusing operation, and moreover, there are a number of proposals which aim to improve them.

Especially with respect to the AF apparatuses of the industrial field, requirements are not limited to operability or improved throughput, and there is a need for applications such as exhaustively detecting or measuring faults of layers or the line width between patterns of an object under inspection such as a semiconductor wafer on which multiple layers are formed and which have differences in level, accurately measuring slight differences in level of the object under inspection, and the like. Therefore, there are proposals of AF apparatuses which have sufficient ability to inspect or measure these. With respect to such AF apparatus of such the industrial field, “active-type AF” is widely applied in which light such as infrared laser is radiated on an object under inspection and a focusing operation is conducted by detecting the state of the reflected light, because of adaptability to the object under inspection, shortening the AF time, and the like.

As an example of the active-type AF, “knife-edge method” is well-known. Furthermore, with respect to the focusing position, there is an explanation in detail in Japanese Patent Application, First Publication NO/2001-296469.

However, with respect to the AF apparatus applying the generally used active-type, as shown in FIG. 8A, the spot light radiated on the object under inspection is a single and very narrow/small luminous flux (hereinafter, this is called the single spot method). As shown in FIG. 8B, light is scattered at the edge portion close to the level difference of the object under inspection, that is, a lack of volume of signal light that is expected to return in normal cases, and therefore, the AF operation is unstable. Furthermore, as shown in FIG. 8C, if the object under inspection which has multiple level differences is inspected in one field of view, only the level difference of a portion on which the spot light is radiated is focused. However, other portions are not focused well. Therefore, this is not efficient for, for example, a line width measuring in which pattern images inside the field of view is recognized.

With respect to such a problem, recently there is a proposal in which the size of the radiated light is widened by arranging the laser which is radiated on the object under inspection so as to be a slit shape, and improves both instability of operation at the edge portion and AF operation ability on an object under inspection which has level differences (for example, see Japanese Patent Application, First Publication No. H10-161195).

Furthermore, there is a proposal (for example, see Japanese Patent Application, First Publication No. 2001-82926) in which, in order to improve the operation ability, a collimator lens is vibrated with a voice coil motor vibrating the spotlight on a wafer so as to make the radiated light a line shape, and a position detection signal is generated.

In such the method, a cylindrical lens is inserted in the middle of the laser luminous flux, so that the radiated light is arranged so as to be a slit shape as shown in FIG. 9A, the probability of returning light at an edge portion close to the level difference as shown in FIG. 9B is increased, and with respect to level differences shown in FIG. 9C, a position which corresponds to the average of multiple level differences is focused. Furthermore, a method is proposed in which a diffraction grating is applied so as to enlarge an area of the radiated light on the object under inspection (for example, see Japanese Patent Application, First Publication No. 2001-296469). (Hereinafter, a method of radiating multiple beams in a spot shape is called a multi spot method.)

### SUMMARY OF THE INVENTION

In view of the above-described background, the present invention has been conceived and has an object to provide an observation apparatus with a focal position control mechanism that radiates a laser on the inside of an area desired to be focused in order not to be affected by the influence of level differences between patterns or reflection rates outside the area desired to be focused. Therefore, the apparatus can focus on an object under inspection with multiple level differences, and can realize a stable focus.

An observation apparatus with a focal position control mechanism of the present invention includes: an observational optical system which emits radiated light on an object under inspection via one of a plurality of interchangeable object lenses and which includes an imaging device for observing light from the object under inspection; a focal point detection optical system which includes both a light radiation portion which radiates non-visible light on the object under inspection via the object lens of the observational optical system and an photo-electric conversion portion which is arranged on an image surface of a light figure of the non-visible light reflected from the object under inspection and outputs signals corresponding to the position of the light figure inside the image surface, wherein the focal point detection optical system detects the relative distance between the object lens and the object under inspection; an object position adjusting unit which adjusts the focal position of the object under inspection based on the output signals from the focal point detection optical system; and a diaphragm unit which adjusts a radiation area or a reception area of the non-visible light.

This observation apparatus with the focal position control mechanism can block or shade outside visible light radiating on a protruding portion extending out of an imaging area even though it is inside the real field of view by using a diaphragm unit, and can adjust the position of the object under inspection upon adjusting the distance by limiting the incidence of the outside visible light which is necessary for observation or inspection coming into an opt-electric conversion portion so as to only be inside the imaging area.

An observation apparatus with a focal position control mechanism of the present invention is the above-described observation apparatus with a focal position control mechanism, wherein the focal point detection optical system includes an intermediate imaging point of the non-visible light, and the diaphragm unit is arranged at the intermediate imaging point.

This observation apparatus with the focal position control mechanism can radiate while more effectively limiting the radiation area of the outside visible light by arranging the diaphragm unit which has a diaphragm diameter corresponding to the imaging area at an intermediate imaging point.

An observation apparatus with a focal position control mechanism of the present invention is the above-described observation apparatus with focal position control mechanism, wherein the diaphragm unit is arranged between the object under inspection and the object lens.

An observation apparatus with focal position control mechanism of the present invention is the above-described observation apparatus with a focal position control mechanism, wherein the focal point detection optical system includes an imaging lens which forms an image from the non-visible light on the otpo-electric conversion portion, and the diaphragm unit is arranged between the imaging lens and the photo-electric conversion portion.

This observation apparatus with the focal position control mechanism can control radiation while more preferably limiting the radiation area of the non-visible light inside of the imaging area by arranging the diaphragm which has a diaphragm diameter corresponding to the imaging area at the above described position.

An observation apparatus with a focal position control mechanism of the present invention is the above-described observation apparatus with focal position control mechanism, wherein the diaphragm unit includes multiple and selective fixed diaphragms which have different diaphragm diameters from each other.

With respect to this observation apparatus with the focal position control mechanism, it is possible to select the diaphragm diameter which is the most appropriate for the imaging device and the imaging area.

An observation apparatus with a focal position control mechanism of the present invention is the above-described observation apparatus with a focal position control mechanism, wherein the diaphragm unit includes an adjustable diaphragm providing a diaphragm diameter that is adjustable.

With respect to this observation apparatus with the focal position control mechanism, it is necessary to provide multiple diaphragm diameters which are expected to be the most appropriate for the imaging device and the imaging area, and it is possible to select along with adjusting in accordance with the occasion.

An observation apparatus with a focal position control mechanism of the present invention is the above-described observation apparatus with a focal position control mechanism, further including a control portion which adjusts the diaphragm diameter of the diaphragm unit based on output signals from the object position adjusting unit.

This observation apparatus with the focal position control mechanism can automatically adjust or select the most appropriate diaphragm diameter with respect to the imaging area, and it is possible to preferably adjust in short time.

In accordance with the present invention, it is possible to improve a focusing stability inside the imaging area of the object under inspection and to improve observation ability. Especially upon observing faults or errors of the pattern and the like, it is possible to accurately detect faults or errors, to easily compare between faults/errors and a reference image, and to improve the accuracy of grouping of faults/errors.

### BRIEF DESCRIPTION OF THE DRAWINGS

FIG. 1 is a schematic figure showing a constitution of an AF apparatus for a microscope of a first embodiment of the present invention.

FIG. 2A is a figure showing an object under inspection to be inspected which has a level difference and which is observed by using the AF apparatus of the first embodiment of the present invention.

FIG. 2B is a figure showing a state of a spotlight radiated on an object under inspection, which has a level difference in the case of applying a single spot radiation method.

FIG. 2C is a figure showing a state of a spotlight radiated on the object under inspection, which has a level difference, in the case of applying a multiple spot radiation method.

FIG. 3A is a figure, with respect to the AF apparatus for a microscope of the first embodiment of the present invention, showing an object under inspection with unevenness or irregularities which are to be observed and have a different height.

FIG. 3B is a figure, with respect to an object under inspection with unevenness or irregularities which are to be observed and which have different height, when applying a single spot radiation method, showing both the state of a radiated spotlight on the object under inspection and a state of the spotlight on a photo-detector at that time.

FIG. 3C is a figure, with respect to an object under inspection with unevenness or irregularities which are to be observed and which have different height, in the case of applying a multiple spot radiation method, showing both a state of a radiated spotlight on the object under inspection and a state of the spotlight on a photo-detector at that time.

FIG. 4 is an explanation figure, with respect to the AF apparatus for a microscope of the first embodiment of the present invention, showing a relationship between an optical sight and an imaging area upon observing an object under inspection with a level difference.

FIG. 5 is a schematic figure showing a constitution of an AF apparatus for a microscope of a second embodiment of the present invention.

FIG. 6 is a schematic figure showing a constitution of an AF apparatus for a microscope of a third embodiment of the present invention.

FIG. 7 is a schematic figure showing a constitution of an AF apparatus for a microscope of a fourth embodiment of the present invention.

FIG. 8A is a figure showing a state of spotlight radiated on a flat surface of an apex portion of the object under inspection which has unevenness in the case of applying a single spot radiation method.

FIG. 8B is a figure showing a state of spotlight radiated on an edge portion of an apex portion of the object under inspection which has unevenness in the case of applying a single spot radiation method.

FIG. 8C is a figure, in the case of applying a single spot radiation method, showing a state of a spotlight radiated on an object under inspection which has unevenness or irregularities having different height.

FIG. 9A is a figure showing a state of a spotlight radiated on a flat surface of an apex portion of the object under inspection which has unevenness in the case of applying a slit-state multiple spot radiation method.

FIG. 9B is a figure showing a state of a spotlight radiated on an edge portion of an apex portion of the object under inspection which has unevenness in the case of applying a slit-state multiple spot radiation method.

FIG. 9C is a figure, in the case of applying a slit-state multiple spot radiation method, showing a state of a spotlight radiated on an object under inspection which has unevenness or irregularities having different height.

FIG. 10 is an explanation figure showing another example of a fixed diaphragm of AF apparatus for a microscope of the first embodiment of the present invention.

FIG. 11 is an explanation figure showing another example of a movable diaphragm of an AF apparatus for a microscope of the first embodiment of the present invention.

### DETAILED DESCRIPTION OF THE INVENTION

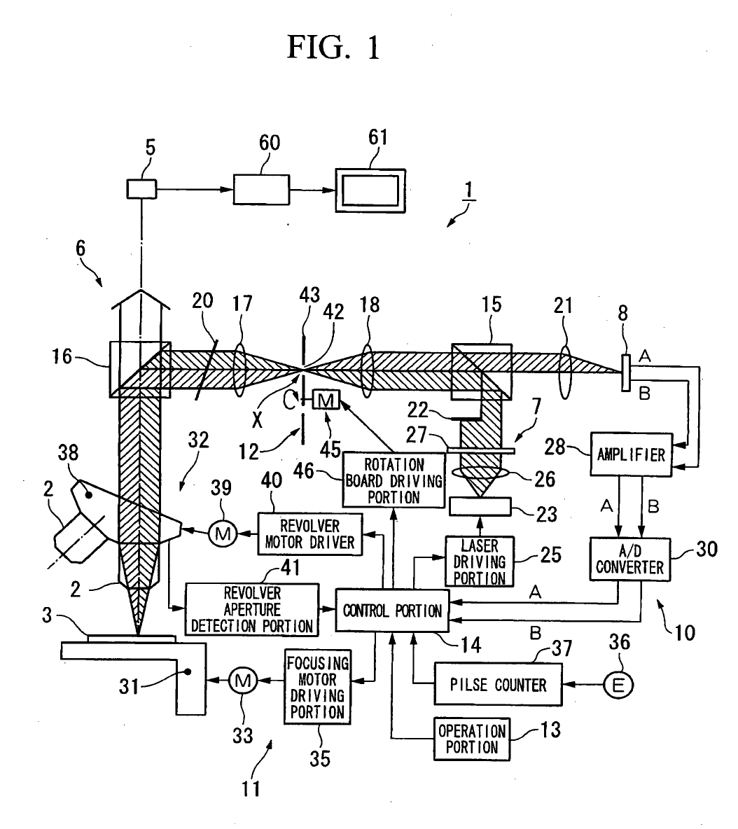

Referring to FIGS. 1-4, a first embodiment of the present invention is explained.

As shown in FIG. 1 an AF apparatus for a microscope of this embodiment includes: an observational optical system 6 which radiates light on an object under inspection 3 via one of multiple interchangeable objective lens 2 and which has a CCD (imaging device) 5 for observing reflected light from the object under inspection 3; a light flooding portion 7 which radiates a laser (non-visible light) of infrared wavelength on the object under inspection 3 via the objective lens 2 of the observational optical system 6; a focal point detection optical system 10 which has a photo-detector (photo-electric conversion portion) 8 that is arranged at an image surface of a light figure of the reflected laser from the object under inspection, output signals corresponding to a position of the light figure inside the image surface, and detects the relative distance between the objective lens 2 and the object under inspection 3; an object position adjusting unit 11 which adjusts the focal position of the object under inspection 3 based on the output signals from the focal point detection optical system 10; a diaphragm unit 12 which adjust an area on which the laser is radiated so as to be inside the imaging area of the CCD 5; and a control portion (control portion) 14 which adjusts the diaphragm diameter of the diaphragm unit 12 based on the output signals of an operation portion 13.

The focal point detection optical system further includes: a polarized beam splitter 15 which splits the optical paths of both the outgoing beam from the light flooding portion 7 and the reflected beam from the object under inspection 3; a dichroic mirror 16 which deflects the reflected light from the object under inspection 3 to a direction towards the polarized beam splitter 15 along with deflecting a direction of the outgoing beam from the object under inspection 3; a pair of lens 17 and 18 which condense the laser once between the polarized beam splitter 15 and the dichroic mirror 16, and intermediately project at a point X which is conjugate to the focal point of the objective lens 2; a ¼wave plate 20 which circularly polarizes the laser in order to restrain or control the polarization characteristic of the object under inspection 3; an imaging lens 21 which is arranged between the polarized beam splitter 15 and the photodetector 8 and which forms an image of the laser on the photodetector 8; and a knife-edge 22 which is arranged between the light flooding portion 7 and the polarized beam splitter 15 and which makes the laser so as to be in a semicircular shape.

The light flooding portion 7 includes: a base light source 23 which radiates a laser; a laser driving portion 25 which drives this base light source 23; a collimator lens 26 which converts the radiated light to parallel light; and a diffraction grating 27 which is arranged at a conjugate position to a pupil of the object lens 2 and which converts the parallel light to multiple spotlights that are multipoint arranged in a line. Moreover, the photodetector 8 is connected to the control portion 14 via both an amplifier 28 which amplifies the output signals that are photo-electrically converted by the photodetector 8, and an A/D converter 30 which converts the output signals amplified by the amplifier 28 from analog to digital.

It should be noted that it is sufficient if the diffraction grating 27 is arranged at a position at which the luminous flux of the reflected light from the object under inspection 3 does not pass through, and it is possible to arrange the diffraction grating 27 at a position between the knife-edge 22 and the polarized beam splitter 22.

The photodetector 8 roughly divides the image surface of the light figure of the reflected light from the object under inspection 3 into two portions including an area A and an area B, and can output signals corresponding to both the areas. In this embodiment, as shown in FIG. 1, the areas A and B are arranged at an upside and a downside corresponding to a position on which an image of the edge of the knife-edge 22 is projected.

The control portion 14 conducts a calculation operation of these signals, and adjusts the focusing point.

The object position adjusting unit 11 includes: a supporting table 31 on which the object under inspection is mounted; an electric revolver 32 which has the object lens 2 and which is rotatable in order to exchange the object lens 2; a focusing motor 33 which vertically moves the supporting table 31; a focusing motor driving portion 35 which drives and controls the focusing motor 33; an encoder 36 which detects the rotation speed of the focusing motor 33; and a pulse counter 37 which is connected to the encoder 36 and which detects the rotation direction and a rotation amount.

The supporting table 31 is set to be vertically movable with respect to the electric revolver 32.

The electric revolver 32 includes: a revolver main body 38 which has an attachment aperture that can fix or attach multiple object lenses 2; a revolver rotation motor 39 which rotates the revolver main body 38 in order to insert any object lens 2 in the middle of the optical path; a revolver motor driver 40 which electrically drives the revolver rotation motor 39; and a revolver aperture detection portion 41 which detects the position of the attachment aperture of the revolver main body 38 to which the object lens 2 is attached.

The diaphragm unit 12 includes: multiple fixed diaphragms 42 which respectively have different diaphragm diameters and which are selective; a fixed diaphragm rotation board 43 which can move the desired fixed diaphragm 42 to an intermediate imaging position between a pair of lenses 17 and 18; a rotation board motor 45 which rotates the fixed diaphragm rotation board; and a rotation board driving portion 46 which drives the rotation board motor 45.

Next, operation methods, influences and effects of an AF apparatus for the microscope 1 of this embodiment is explained, especially with respect to a case of conducting an AF focusing operation on an area close to level differences of the object under inspection including level difference portions.

It should be noted that a laser radiation method in accordance with the multiple spot method by using the focal point detection optical system 10 and adjusting the focal point of the object under inspection 3 by using the object position adjusting unit 11 are conducted in the same manner described in Japanese Patent Application, First Publication No. 2001-206469.

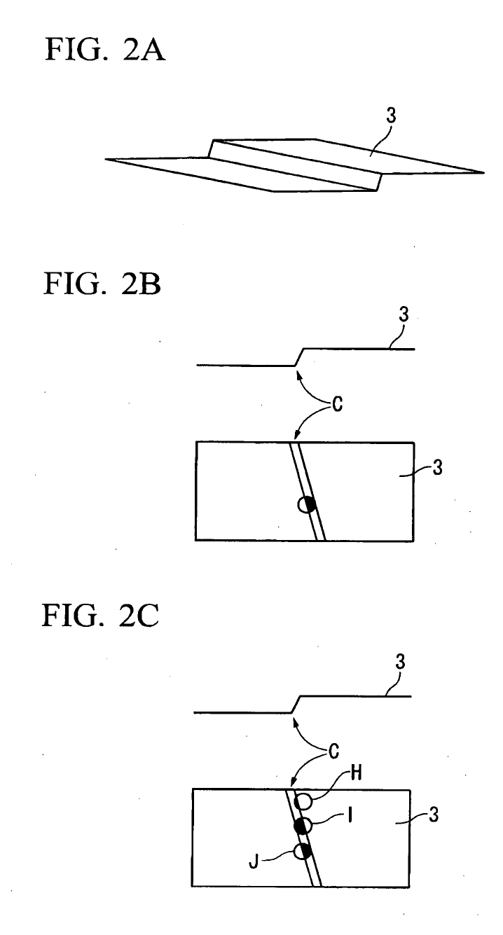

When a level difference shown in FIG. 2A is observed, in accordance with the single spot method, as shown in FIG. 2B, the spotlight on the object under inspection 3 is single. Therefore, most of the reflected light of the spotlight is scattered light and does not return to the photodetector 8, and it is not possible to conduct an AF operation.

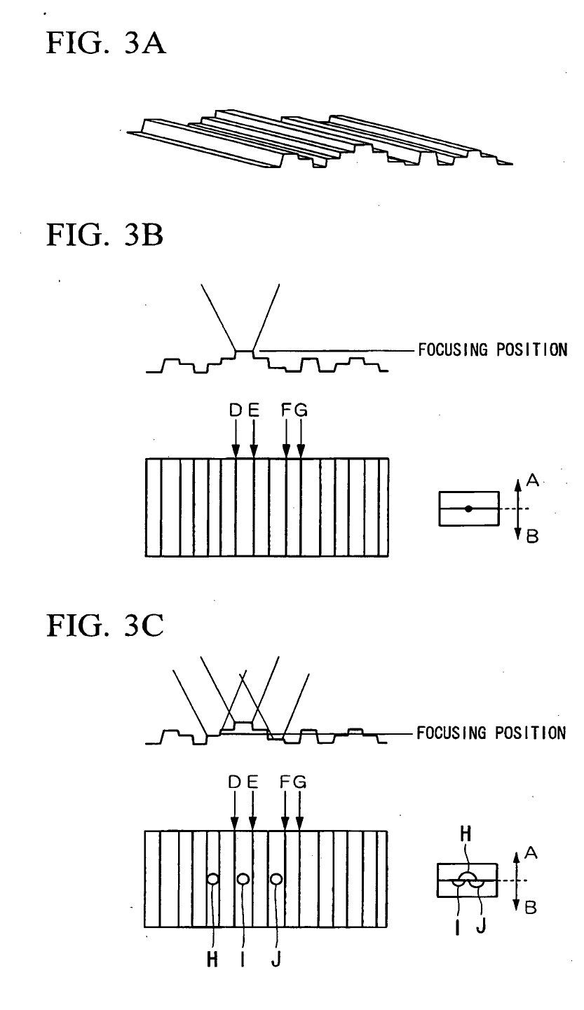

Moreover, when a level difference shown in FIG. 3A is observed, as shown in FIG. 3B, only a position of the spotlight projected on the object under inspection 3 is focused. Therefore, especially in the case of using the object lens 2 which is high power, images of other level differences of the object under inspection is greatly out of focus. Therefore, it may be possible to measure a width between D and E in the figure; however, it is not possible to measure a width between F and G in the figure.

On the other hand, in the case of the multiple spot method, as shown in FIG. 2C, multiple spotlights project on the object under inspection 3. Therefore, for example, even if most of the light from multiple spotlights arranged in a line and shown by H in the figure is scattered and does not return to the light reception side, reflected light of spotlights shown by I and J in the figure can return to the light reception side and it is possible to obtain sufficient detection signals.

Moreover, as shown in FIG. 3C, light from multiple spotlights projected on different level differences independently form images on the photodetector 8. Therefore, it is possible to focus on a position of average height among level differences, and there may be level differences inside a sight which are slightly out of focus. However, compared to the single spot method, there is no point which is largely out of focus, and it is possible to measure the pattern width between D and E and the pattern width between F and G in the figure.

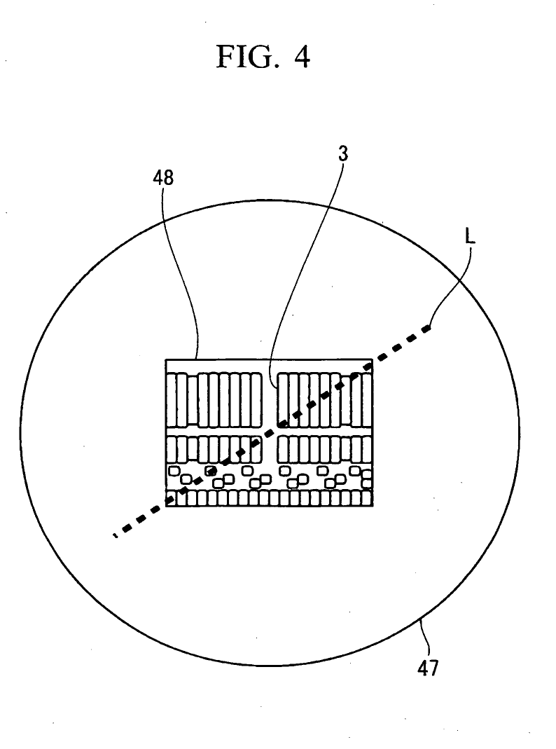

As shown in FIG. 4, it should be generally noted that an optical sight 47 is approximately a circle. However, an imaging area 48 is in a rectangular state, and inside the optical sight 47, spotlights L which are multiple points are arranged in the direction of a diagonal line of the imaging area 48. Therefore, because the photodetector 8 receives signals from the multiple spotlights outside the imaging area 48, there are cases in which signal operations are conducted under influences of such portions, and there are cases in which images inside the imaging area 48 which are visible are not sufficiently focused.

In such the cases, a spotlight switching switch which is provided inside the operation portion 13 and which is not shown in the figures is operated, the rotation board motor 45 is driven in accordance with a command which is output from the control portion 14 to the rotation board driving portion 46, the fixed diaphragm rotation board 43 is rotated, the fixed diaphragm 42 is selected in order to arrange the laser spotlight radiated on the object under inspection 3 so as to be inside the imaging area 48, and the fixed diaphragm 42 is set at the above-described intermediate imaging position.

As a result, multiple laser spotlights are radiated only inside the imaging area 48 even though it is inside the optical sight 47 and are reflected. Therefore, the photodetector 8 receives only reflected light from the inside of the imaging area 48 which is not affected from level differences of patterns which are at positions outside the imaging area 48, and the position of the focal point is adjusted based on this.

On the other hand, it is possible to apply a constitution in which the control portion detects the signals from the revolution aperture position detection portion 41, determines the object lens 2 to be used based on the signals, selects the fixed diaphragm 42 which corresponds to the imaging area of the imaging camera to be used, and transmits a signal to the rotation board driving portion 46 based on the selected fixed diaphragm 42, and after that the rotation board driving portion 46 rotates the driving board motor 45 so as to automatically set the most appropriate fixed diaphragm 42.

In accordance with the AF apparatus for microscope 1, the diaphragm unit 12 which has a diaphragm diameter corresponding to the imaging area 48 is arranged at the intermediate imaging position. Therefore, it is possible to limit the length of the radiated spotlight of the laser based on the size of the imaging area 48.

Moreover, by applying the control portion 14, it is possible to adjust the appropriate pinhole 42 which is the most appropriate to the imaging area 48 at the intermediate imaging position, and it is possible to appropriately adjust it quickly.

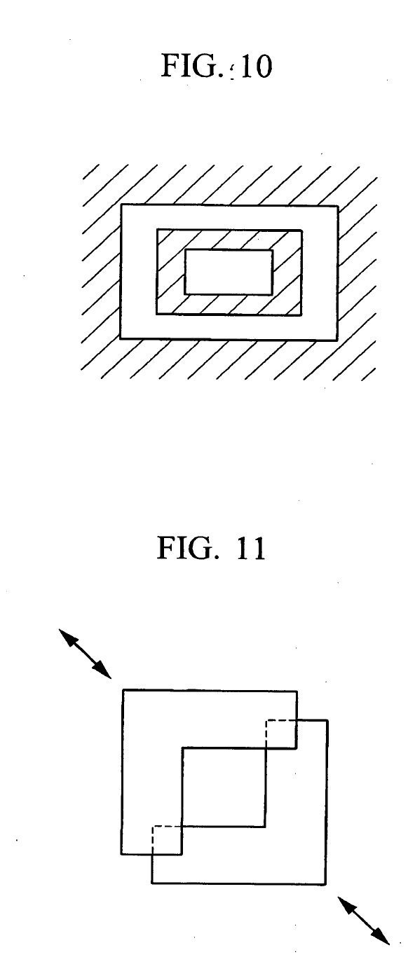

It is possible that the shape of the fixed diaphragm 42 be, as shown in FIG. 10, a shape which shields the outside of the imaging area from the inside of the imaging area based on a purpose. In such a case, it is possible to place weight on the center portion and surrounding portion of the imaging area. Moreover, it is possible to shield the outside of the imaging area and to continuously change the transmissivity along a direction from the center portion to the surrounding portion.

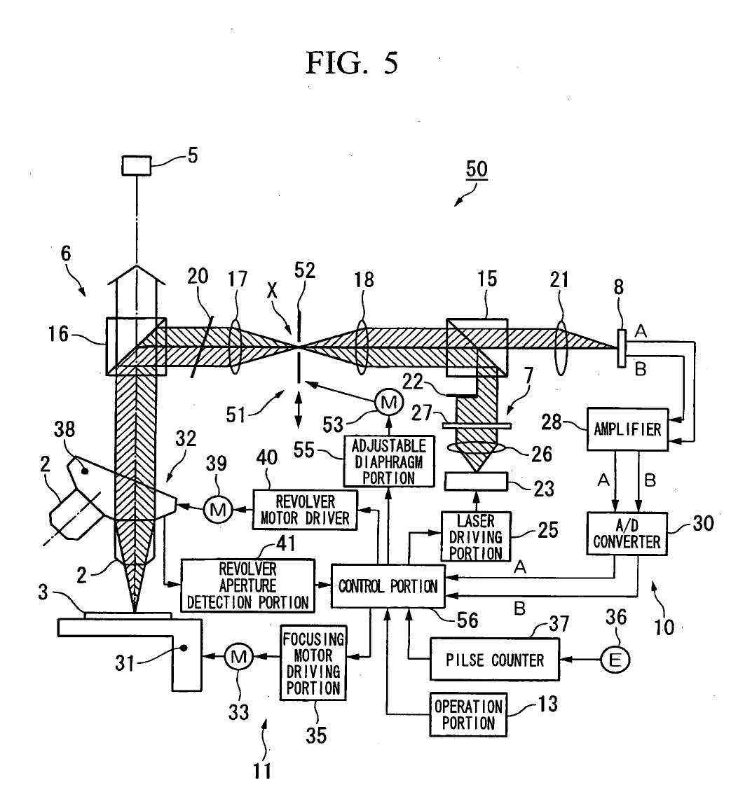

Next, referring to FIG. 5, a second embodiment is explained.

It should be noted that with respect to the same constitutional elements described in the first embodiment, the same reference numerals are assigned and explanations are omitted.

One difference between the second embodiment from the first embodiment is that the AF apparatus for microscope 50 of this embodiment provides, for example: an adjustable diaphragm 52 such as a blade diaphragm applied to a camera and the like which can adjust the diaphragm diameter; an adjustable diaphragm motor 53 which drives the adjustable diaphragm 52; and an adjustable diaphragm driving portion 55 which drives this adjustable diaphragm motor 53.

Moreover, a control portion 56 is provided so as to be able to adjust the diaphragm diameter of the adjustable diaphragm 52 based on an output signal from the object position adjusting unit 11.

In this AF apparatus for the microscope 50, the control portion 56 detects a signal from the revolution aperture position detection portion 41 upon focusing. At this time, the object lens 2 of a predetermined magnification is attached to each of the attachment apertures of the revolver main body 38. Therefore, the object lens 2 currently used is distinguished based on the signal from the revolution aperture position detection portion 41. The control portion 56 calculates the diaphragm diameter so as to be inside the imaging area of the imaging aperture in accordance with the magnification of the object lens 2. Otherwise, it is possible to provide memory which stores a table of the diaphragm diameters corresponding to the magnifications. After that, the control portion 56 outputs a command to the adjustable diaphragm driving portion 55 in order to drive the adjustable diaphragm motor 53, and the diaphragm diameter of the adjustable diaphragm 52 is changed so as to adjust the length of the radiated spotlight radiated on the object under inspection 3 to approximately the same length of a diagonal line of the imaging area 48.

Otherwise, it is possible to respectively move a pair of L shaped members which constitute the adjustable diaphragm in diagonal directions as shown in FIG. 11 by using a driving unit which is not shown in the figures. Moreover, it is possible to move the pair of members to any position inside the imaging area while maintaining their relative positions.

By applying this AF apparatus for the microscope 50, it is possible to obtain the same functions and effects as described in the first embodiment, moreover, it is not necessary to set the most appropriate and multiple diaphragm diameters beforehand, it is possible to adjust the length of the radiated light of the multiple spots, and it is possible to more appropriately conduct the focusing operation.

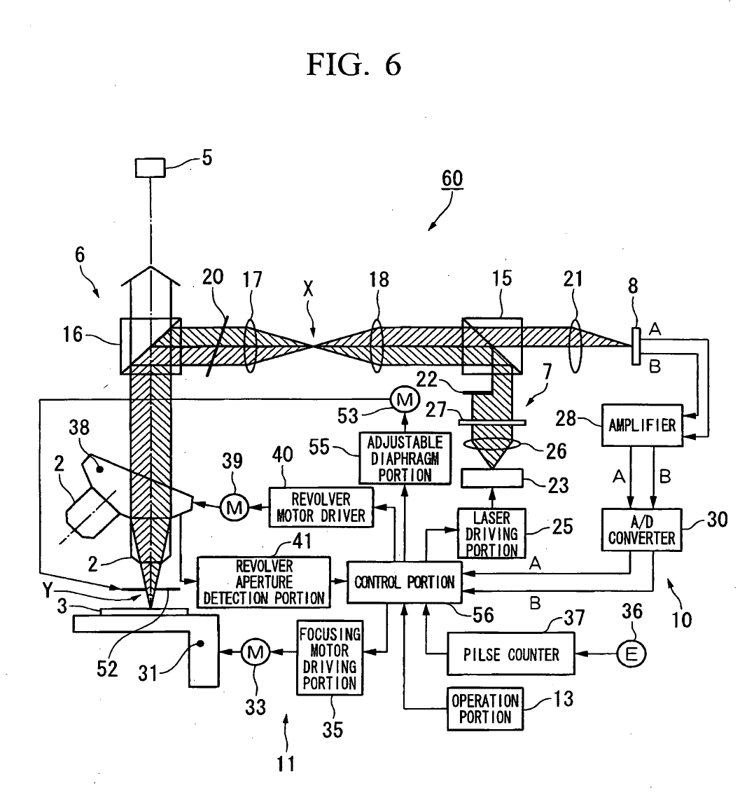

Next, referring to FIG. 6, a third embodiment is explained.

It should be noted that with respect to same constitutional elements described in the above-described embodiments, the same reference numerals are assigned and the explanations are omitted.

One difference between the third embodiment and the second embodiment is that the adjustable diaphragm 52 of an AF apparatus for a microscope 60 of this embodiment is arranged at a position Y between the object under inspection 3 and the object lens 2,

By applying this AF apparatus for microscope 60, the adjustable diaphragm 52 is arranged at a position at which a bundle of laser is converged. Therefore, as described in the second embodiment, it is possible to more preferably limit the length of the radiated spotlight of the laser so as to be inside the imaging area 48 because the diaphragm of the adjustable diaphragm 52 is adjustable.

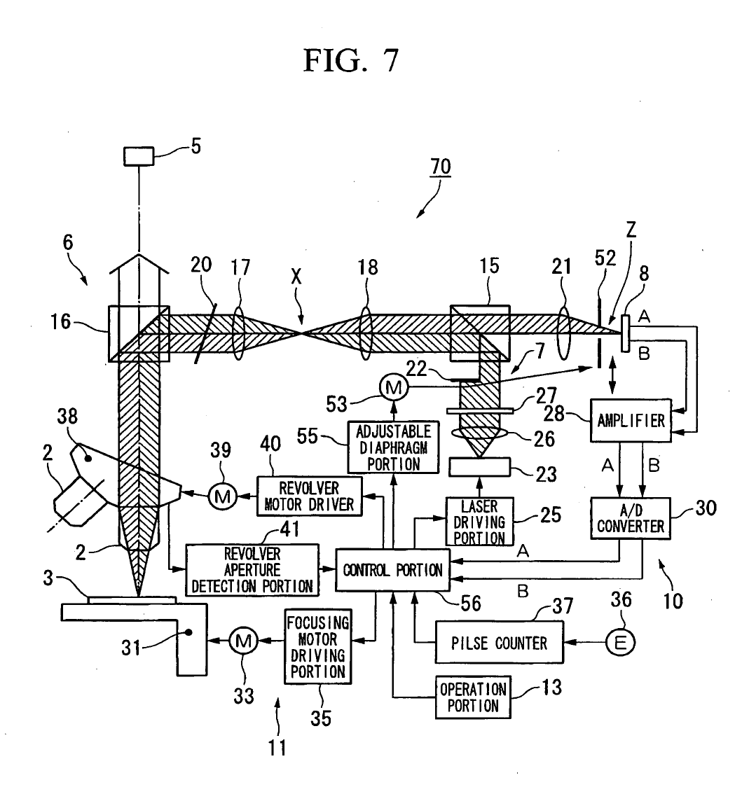

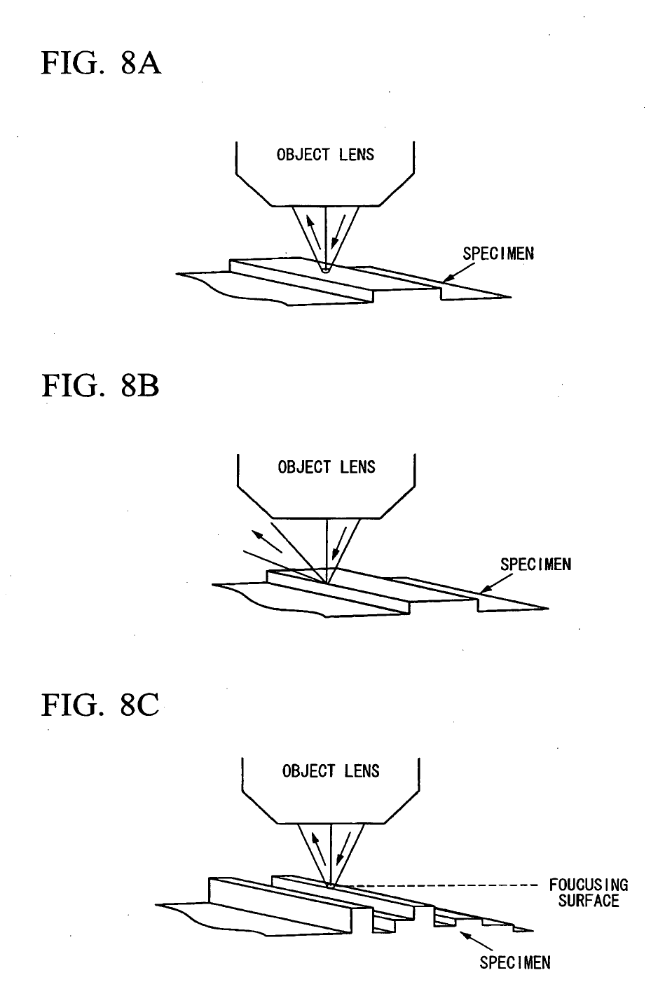

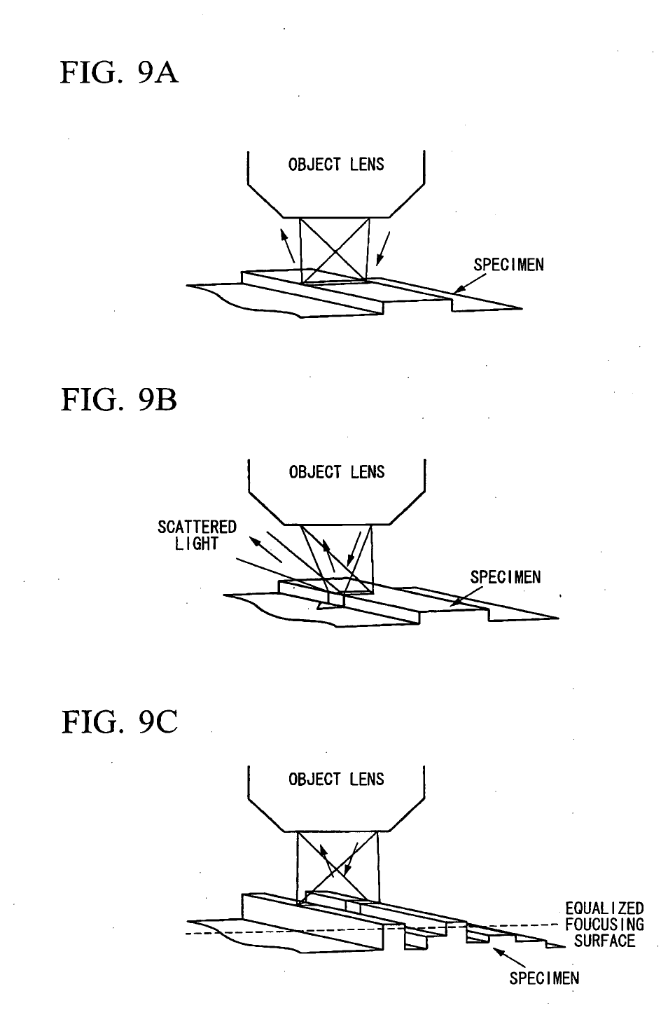

Next, referring to FIG. 7, a fourth embodiment is explained.

It should be noted that with respect to the same constitutional elements described in the above-described embodiments, the same reference numerals are assigned and explanations are omitted.

One difference between the fourth embodiment and the third embodiment is that the adjustable diaphragm 52 of an AF apparatus for a microscope 70 of this embodiment is arranged at a position Z between the imaging lens 3 and the photodetector 8.

By applying this AF apparatus for the microscope 70, as described in the second and the third embodiments, the adjustable diaphragm 52 is arranged at a position at which a bundle of lasers converge. Therefore, because the diaphragm of the adjustable diaphragm 52 is adjustable, it is possible to obtain the same effects as described in the second and the third embodiments.

It should be noted that the technical scope of the present invention is not limited by the above-described embodiments, and it is possible to have various design modifications which do not deviate from the gist of this invention.

For example, in the above-described embodiment, with respect to the object position adjusting unit 11 which adjusts an interval or gap between the object under inspection and the object lens, the supporting table 31 is driven upward and downward against the electric revolver 32. However, it is possible to drive the electric revolver upward and downward against the supporting table.

Moreover, the multi spot method is explained in the above-described embodiment. However, even if radiation methods of a slit shape or a line shape described in Japanese Patent Application, First Publication No. 2001-296469 or Japanese Patent Application, First Publication No. H10-161195 are applied, it is naturally possible to obtain the same effects by arranging the diaphragm unit at a position which is a conjugate position of the image.

The present invention can be applied to the object under inspection with multiple level differences because it is possible to realize an stable focus by the radiating laser only inside the area that is desired to be focused so as not to be affected by the influence of level differences of patterns or reflection rates outside the area desired to be focused.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An observation apparatus with a focal position control mechanism comprising:
an observational optical system which emits radiated light on an object under inspection via one of a plurality of interchangeable object lenses, and which comprises an imaging device for observing light from the object under inspection;
a focal point detection optical system which comprises both a light radiation portion which radiates non-visible light on the object under inspection via the object lens of the observational optical system and an photo-electric conversion portion which is arranged on an image surface of a light figure of the non-visible light reflected from the object under inspection and which outputs signals corresponding to a position of the light figure inside the image surface, wherein the focal point detection optical system detects a relative distance between the object lens and the object under inspection;
an object position adjusting unit which adjusts a focal position of the object under inspection based on the output signals from the focal point detection optical system; and
a diaphragm unit which adjusts a radiation area or a reception area of the non-visible light.

2. An observation apparatus with a focal position control mechanism according to claim 1, wherein
the focal point detection optical system comprises an intermediate imaging point of the non-visible light; and
the diaphragm unit is arranged at the intermediate imaging point.

3. An observation apparatus with a focal position control mechanism according to claim 1 which, wherein the diaphragm unit is arranged between the object under inspection and the object lens.

4. An observation apparatus with a focal position control mechanism according to claim 1, wherein
the focal point detection optical system comprises an imaging lens which forms an image from the non-visible light on the otpo-electric conversion portion; and
the diaphragm unit is arranged between the imaging lens and the photo-electric conversion portion.

5. An observation apparatus with a focal position control mechanism according to claim 2, wherein the diaphragm unit comprises multiple and selective fixed diaphragms which have different diaphragm diameters from each other.

6. An observation apparatus with a focal position control mechanism according to claim 3, wherein the diaphragm unit comprises an adjustable diaphragm providing a diaphragm diameter that is adjustable.

7. An observation apparatus with a focal position control mechanism according to claim 1, further comprising a control portion which adjusts a diaphragm diameter of the diaphragm unit based on output signals from the object position adjusting unit.
